(19) United States
(12) Patent Application Publication
(10) Pub. No.: US 2009/0115610 A1
(43) Pub. Date: May 7, 2009

(54) Sensor/Actuator Arrangement and Method for Locating and Guiding Moving Objects and/or People in an Area With the Aid of a Sensor/Actuator Arrangement

(76) Inventors: Axel Steinhage, Kirchseeon (DE); Christl Lauterbach, Hoehenkirchen-Siegertsbrunn (DE)

Correspondence Address: MARTIN & FERRARO, LLP, 1557 LAKE O'PINES STREET, NE, HARTVILLE, OH, 44632, US

(21) Appl. No.: 12/224,187

(22) PCT Filed: Feb. 16, 2007
(86) PCT No.: PCT/DE2007/000323

§ 371 Date: Aug. 20, 2008

(30) Foreign Application Priority Data
Feb. 20, 2006 (DE) 10 2006 007 780.6

(51) Int. Cl. G08B 13/14

(52) U.S. Cl. 340/572.1

(57) ABSTRACT

A sensor/actuator arrangement has at least one sensor element and/or at least one actuator element, and also at least one transmission/reception unit which has at least one first transmission/reception element and a second transmission/reception element for sending and/or receiving signals, wherein the first transmission/reception element is set up such that an identification information item contained in the first transmission/reception element can be read wirelessly using a first communication channel, and wherein the second transmission/reception element is electrically coupled to the at least one sensor element and/or to the at least one actuator element such that the second transmission/reception element can be used to send a sensor signal provided by the at least one sensor element using a second communication channel, and/or an actuator control signal received using the second communication channel can be provided on the at least one actuator element.

The invention relates to a sensor/actuator arrangement and a method for locating and guiding moving objects and/or people using a sensor/actuator arrangement.

To date, position-finding or control for robots or in the case of guidance systems has required a high level of complexity for training the system and orienting the robots in buildings. For this, the currently available systems require cameras, for example, with picture evaluation, distance measurement etc. A relatively new method involves orienting robots using RFID tags (Radio Frequency Identification tags) integrated in a floor covering. When a robotic vehicle is equipped with an RFID reading device (RFID reader) and the floor area with the integrated RFID tags is mapped, the vehicle can read in the number of a tag as it moves over the tag and can locate itself using the stored map, see [1], for example.

It is not possible to locate people using the method described above, because a person normally does not wear an RFID reader on his body. By way of example, people can be located using a floor covering equipped with a self-organizing sensor network, i.e. a sensor network in which the position of the individual network elements within the sensor network is determined automatically relative to a reference position. In this case, the respective position is determined by means of local interchange of electronic messages only between network elements which are arranged directly next to one another. This self-organizing sensor network has the drawback that the self-organization produces a high level of computation complexity. The integrated network elements therefore place a relatively high level of demand on the performance of the integrated processor and have a high memory requirement for the firmware. In addition, the data connections of such a system are limited to one side of the network and therefore sometimes give rise to an installation and/or reliability problem during use. Sensor signals are not forwarded directly to a central control unit, but rather are forwarded from node to node in the network. This has the drawback that the system becomes relatively slow and that sometimes signals are even not processed when the data traffic in the network becomes too great.

[3] discloses an electrical household appliance having at least one sensor for capturing at least one operating parameter and at least one actuator for influencing at least one operating parameter of the electrical household appliance, the at least one sensor and the at least one actuator being electrically coupled to a central computation and control unit for controlling the electrical household appliance, and wherein the central computation and control unit is coupled to a communication unit which allows wireless communication with an external remote station.

[4] discloses a method and a telematics appliance for creating and transmitting traffic-related data, wherein the data have been created using sensors on board a motor vehicle.

[5] discloses a method for capturing and processing traffic telematics data, wherein the data are captured by satellite-assisted capture systems.

The invention is based on the problem of providing a system for locating and/or guiding articles and/or people which at least to some extent gets around or avoids the drawbacks known from the prior art.

The problem is solved by a sensor/actuator arrangement and a method for locating and guiding moving objects, articles and/or people on an area using a sensor/actuator arrangement having the features according to the independent patent claims.

Exemplary refinements of the invention can be found in the dependent patent claims. The further refinements of the invention which are described in connection with the sensor/actuator arrangement also apply, mutatis mutandis, to the method.

The invention provides a sensor/actuator arrangement which has at least one sensor element and/or at least one actuator element. In addition, the sensor/actuator arrangement has at least one transmission/reception unit, which at least one transmission/reception unit has at least one first transmission/reception element and a second transmission/reception element for sending and/or receiving signals, wherein the first transmission/reception element is configured such that an identification information item contained in the first transmission/reception element can be read wirelessly using a first communication channel, and wherein the second transmission/reception element is electrically coupled to the at least one sensor element and/or to the at least one actuator element such that the second transmission/reception element can be used to send a sensor signal provided by the at least one sensor element using a second communication channel, and/or an actuator control signal received using the second communication channel can be provided on the at least one actuator element.

In the case of a method for locating and guiding moving objects and/or people on an area using a sensor/actuator arrangement, a sensor/actuator arrangement is provided which has a plurality of sensor elements and/or a plurality of actuator elements, and also has a plurality of transmission/reception units which are electrically coupled at least in part to one another and/or to the plurality of sensor elements and/or to the plurality of actuator elements, wherein the plurality of sensor elements and/or the plurality of actuator elements and/or the plurality of transmission/reception units are formed on or in the area. The method involves the sensor elements and/or the transmission/reception units being used to capture information about the positions of moving objects and/or people situated on the area, which information is used for locating the objects and/or people. In addition, the actuator elements and/or the transmission/reception units are used to provide the objects and/or people situated on the area with information, which information is used for guiding the objects and/or people on the area.

One aspect of the invention can be seen in that the sensor/actuator arrangement can be used to locate both objects (such as autonomous robotic vehicles) and people. A robot, for example, can be located by reading the identification information item contained in the first transmission/reception element, whereas a person can be located by sending a sensor signal initiated by the person from the second transmission/reception element coupled to the sensor element as a wireless signal. The use of a first communication channel, in other words a first transmission path, for the communication by the first transmission/reception element and of a second communication channel (transmission path) for the communication by the second transmission/reception element allows a distinction to be drawn between objects and people in a location operation.

Another aspect of the invention can be seen in that an actuator element which is provided with an actuator control signal can be used to provide a person with information which can be used for orienting the person, for example.

In line with one refinement of the invention, the first transmission/reception element of the at least one transmission/reception unit is configured such that the identification information item contained in the first transmission/reception element can be read using a wireless signal at a first transmission/reception frequency. The identification information item is read using the first communication channel, which is in the form of a wireless communication channel, in other words is in the form of a wireless transmission path for data, signals, information etc.

In another refinement of the invention, the at least one transmission/reception unit has at least one electrical connection, wherein the second transmission/reception element of the at least one transmission/reception unit is electrically coupled to the at least one sensor element and/or to the at least one actuator element by means of the at least one electrical connection.

One aspect of the invention can be seen in that in the case of a sensor event the sensor element initiates a sensor signal, which sensor signal is provided on the second transmission/reception element, which is coupled to the sensor element.

In line with another refinement of the invention, the second transmission/reception element of the at least one transmission/reception unit is configured such that the sensor signal provided by the at least one sensor element can be sent as a wireless signal at a second transmission/reception frequency. In this case, the second communication channel is in the form of a wireless communication channel, in other words in the form of a wireless transmission path for data, signals, information etc.

In another refinement of the invention, the second transmission/reception element of the at least one transmission/reception unit is configured such that the actuator control signal can be received as a wireless signal at a third transmission/reception frequency.

The first transmission/reception frequency, the second transmission/reception frequency and the third transmission/reception frequency may be different in pairs. In other words, if the first transmission/reception frequency is denoted by f₁, the second transmission/reception frequency is denoted by f₂ and the third transmission/reception frequency is denoted by f₃, then the following may apply: fᵢ≠fⱼ (∀i, j; i, j ε {1, 2, 3)}; i≠j).

One advantage of using different transmission/reception frequencies f₁, f₂, f₃ for the wireless signal for reading the identification information item, the wireless signal for sending the sensor signal and the wireless signal in the form of an actuator control signal can be seen in that the signals do not influence or disturb one another.

In an alternative refinement of the invention, two or all three of the three transmission/reception frequencies f₁, f₂, f₃ may have the same or essentially the same value. By way of example, the second transmission/reception frequency f₂ (i.e. the frequency of the wireless signal sent by the second transmission/reception element) and the third transmission/reception frequency f₃ (i.e. the frequency of the actuator control signal received by the second transmission/reception element) may be identical, i.e. f₂=f₃.

In line with another refinement of the invention, the second communication channel is in the form of a wired connection, in other words in the form of a wired transmission path for data, signals, information etc. In this case, the sensor signal provided by the at least one sensor element can be sent by the second transmission/reception element as a wired signal, and/or the actuator control signal can be received by the second transmission/reception element as a wired signal.

By way of example, a second communication channel in the form of a wired connection can be provided by at least one current supply line or voltage supply line which is coupled to the at least one transmission/reception unit, or to the second transmission/reception element of the at least one transmission/reception unit. In other words, the data transmission or signal transmission, i.e. the transmission of the sensor signal and/or of the actuator control signal, can be effected using a PLC (Power Line Communication) method.

One advantage of using a PLC method for transmitting the signals (sensor signal and/or actuator control signal) from the second transmission/reception element and to the second transmission/reception element can be seen in that one or more current lines or voltage lines provided for supplying current or for supplying voltage to the at least one transmission/reception unit can also be used for the signal transmission, and therefore no additional signal lines need to be provided for the signal transmission, for example.

Alternatively, the sensor signal and/or the actuator control signal can be transmitted using an optical transmission path or an optical data transmission device, for example using optical fibers or fiber-optic cables.

In line with another refinement of the invention, at least one of the transmission/reception elements is in the form of a radio frequency element (RF element) (also referred to as an RF module), i.e. in the form of a transmission/reception element which has a transmission/reception frequency in the radio frequency range.

In another refinement of the invention, the first transmission/reception element is in the form of an RF element, for example in the form of a passive RF element. A first transmission/reception element in the form of a passive RF element may be operable without a supply voltage being applied to the transmission/reception unit. In this case, the first transmission/reception element in the form of a passive RF element can obtain the power required for it to operate from the wireless signal or radio signal (i.e. the electromagnetic field of the radio signal), for example, which wireless signal is used to read the identification information item contained in the first transmission/reception element.

By way of example, the first transmission/reception element may be in the form of an RFID tag (Radio Frequency Identification tag), for example in the form of a passive RFID tag.

In another refinement of the invention, the identification information item contained in the first transmission/reception element (e.g. the RFID tag) is in the form of an identification information item which is explicit for the at least one transmission/reception unit. The explicit identification information item may be provided in the form of a unique (explicit) number, which number can actually be stipulated when the first transmission/reception element is manufactured and which number can be read in order to locate a robotic vehicle (which has a suitable reading apparatus), for example.

In line with another refinement of the invention, the first transmission/reception element in the form of an RF element (for example in the form of an RFID tag) can have information written to it, for example using a read/write device or a reader/writer. In other words, the first transmission/reception element (e.g. the RFID tag) can have information or data written to it, such as one or more coordinates (coordinate statements), a story number, a service date etc. In other words again, the first transmission/reception element may be configured in the form of a programmable element (e.g. a programmable RFID tag).

In line with another refinement of the invention, the second transmission/reception element is likewise configured in the form of an RF element.

In another refinement of the invention, a second transmission/reception element in the form of an RF element has a second transmission/reception frequency f₂ (for sending the sensor signal) and a third transmission/reception frequency f₃ (for receiving the actuator control signal) which are different than the first transmission/reception frequency f₁. In other words, f₂≠f₁ and f₃≠f₁ are true.

In addition, the second transmission/reception frequency f₂, i.e. the frequency at which a sensor signal provided by a sensor element is sent as a wireless signal by a second transmission/reception element coupled to the sensor element, may be the same as the third transmission/reception frequency f₃, i.e. the same as the frequency of an actuator control signal which is received by a second transmission/reception element coupled to an actuator element.

In line with another refinement of the invention, the at least one transmission/reception unit has one or more of the following elements: a processor element (central processing unit, CPU), a memory element such as a flash memory element and/or a RAM (Random Access Memory) memory element, a timer element or a timer.

In another refinement of the invention, the at least one transmission/reception unit of the sensor/actuator arrangement is coupled to an electrical supply voltage by means of at least one electrical supply voltage connection. The supply voltage can be used to provide the power required for operation of the at least one transmission/reception unit (or of the elements/components produced in the at least one transmission/reception unit) and for operation of the at least one sensor element and/or of the at least one actuator element which is electrically coupled to the second transmission/reception element of the at least one transmission/reception unit. If the at least one transmission/reception unit is connected to the supply voltage by means of a plurality of connections, the resultant redundancy can either prevent failures in the at least one transmission/reception unit completely or can at least significantly reduce the likelihood of such failures.

In line with another refinement of the invention, the at least one transmission/reception unit has at least one switching element, which at least one switching element is electrically coupled to the at least one electrical supply voltage connection. In other words, the at least one supply voltage connection has at least one switching element added. The at least one switching element may be in the form of an electronic switch which is configured such that in the event of an electrical short in the sensor/actuator arrangement the relevant supply path (supply voltage path) is disconnected using the switch. The switching element is therefore also referred to as a power switch. The switching element (power switch) can be used to protect the at least one transmission/reception unit or the elements produced in the at least one transmission/reception unit from the negative effects of a short (for example damage to the elements by a large current) by, as a good example, decoupling the supply paths on which a short is occurring from the transmission/reception unit.

In line with another refinement of the invention, the sensor/actuator arrangement has at least one sensor element, wherein the at least one sensor element may be in the form of a proximity sensor (e.g. in the form of a capacitive proximity sensor) and/or in the form of a temperature sensor and/or in the form of a pressure sensor and/or in the form of an optical sensor and/or in the form of an acoustic sensor. Alternatively, the at least one sensor element may also be in the form of another type of sensor, however.

In another refinement of the invention, the sensor/actuator arrangement has at least one actuator element, wherein the at least one actuator element may be in the form of an indicator element, such as a light-emitting diode (LED).

Alternatively, the at least one actuator element may also be in the form of another indicator element or imaging element, such as a liquid crystal display (LCD) unit, and/or in the form of a sound-wave generation element (e.g. a loudspeaker) and/or in the form of a vibration generation element, however.

In line with another refinement of the invention, the sensor/actuator arrangement has a plurality of sensor elements and/or a plurality of actuator elements, and also a plurality of transmission/reception units which are electrically coupled at least in part to one another and/or to the plurality of sensor elements and/or to the plurality of actuator elements, wherein the plurality of sensor elements and/or the plurality of actuator elements and/or the plurality of transmission/reception units are produced on or in an area (or an area formation).

The area may be a floor area; for example, the area may be part of a floor covering on which it is possible to walk and/or drive, in general a floor covering on which moving or movable objects and/or people can move, such as a carpet or a parquet floor/laminate. Alternatively, the area may be a wall area, in general any area or any area formation.

A sensor/actuator arrangement having a plurality of sensor elements and/or a plurality of actuator elements and also a plurality of transmission/reception units, which transmission/reception units are electrically coupled at least in part to one another and/or to the plurality of sensor elements and/or to the plurality of actuator elements, is, as a good example, in the form of a network of transmission/reception units which are at least in part coupled to one another, in other words networked, wherein the transmission/reception units are also coupled or networked at least in part to the plurality of sensor elements and/or to the plurality of actuator elements. The sensor/actuator arrangement is therefore subsequently also referred to as a sensor/actuator network or a network for short, and the transmission/reception units in this network are subsequently also referred to as network elements.

The network elements may be connected to one another and/or to the sensor elements and/or to the actuator elements and/or to the supply voltage by means of conductive tracks or conductor tracks (or by means of any other electrically conductive elements). The conductive tracks (or the electrically conductive elements) may be inserted or integrated on the area, and in the case of an area in the form of a carpet (in general a textile structure), the electrically conductive tracks may be woven into the carpet (the textile structure), for example.

In another refinement of the invention, the plurality of sensor elements and/or the plurality of actuator elements and/or the plurality of transmission/reception units are produced in a surface covering for the area. In other words, the plurality of sensor elements and/or the plurality of actuator elements and/or the plurality of transmission/reception units may be produced, for example embedded, in a covering or in a surface covering structure for the area.

By way of example, the surface covering structure may be in the form of a wall covering structure (wall covering) for a wall area, in the form of a floor covering structure (floor covering) for a floor area or in the form of a ceiling covering structure (ceiling covering) for a ceiling area. Alternatively, the surface covering structure may be in the form of a covering for any area or for any area formation.

In line with another refinement of the invention, the plurality of sensor elements and/or the plurality of actuator elements and/or the plurality of transmission/reception units (network elements) are produced on the underside of the floor covering and/or on the underside of a wall covering and/or on the underside of a ceiling covering. In this case, the underside of a floor covering, wall covering or ceiling covering is intended to be understood to mean the side of the covering structure which is remote from, in other words: invisible to, an observer of the covering structure, as a good example the back of the covering structure. One advantage of forming the plurality of sensor elements and/or the plurality of actuator elements and/or the plurality of transmission/reception units on the underside of the surface covering structure can be seen in that the visual impression of the area is not impaired by the sensor elements and/or actuator elements and/or transmission/reception units.

In line with another refinement of the invention, each transmission/reception unit or each network element of the sensor/actuator network is coupled to the electrical supply voltage by means of at least two supply voltage connections.

Each connection for the supply voltage may have a switching element (power switch) added which automatically disconnects the relevant supply path in the event of a short in the network. This allows failure of the entire network to be prevented even when an electrical short occurs within the network with possibly a multiplicity of individual network elements, sensor elements and/or actuator elements coupled to one another. In other words, what is known as power routing can prevent a short in the network from pulling down the supply voltage on all network elements.

In line with another refinement of the invention, the supply voltage in the sensor/actuator network has a value which is above the supply voltage value required for an individual transmission/reception unit (network element). This means that transmission losses in the network can be kept down and hence sound operation of the network or of the network elements can be ensured. One or more of the network elements may therefore have a voltage regulator which can be used to reduce the voltage to the value which is suitable for the network element.

In another refinement of the invention, the plurality of sensor elements and/or the plurality of actuator elements and/or the plurality of transmission/reception units (network elements) are arranged in a regular grid, for example in a regular rectangular grid or in a square grid or in a triangular grid.

By way of example, each network element in the sensor/actuator network may be electrically coupled to all directly adjacent network elements (e.g. by means of supply voltage lines), i.e. in the case of a regular rectangular grid or in the case of a square grid with four respective adjacent network elements.

In line with another refinement of the invention, the sensor/actuator arrangement or the sensor/actuator network has at least one transmission/reception device, which transmission/reception device is configured for wireless communication with at least one of the second transmission/reception elements of the plurality of transmission/reception units (network elements) and/or with at least one moving object situated on the area.

The at least one transmission/reception device may be configured as a local transmission/reception device, i.e. the transmission/reception device communicates only with the second transmission/reception elements of those network elements, which network elements are in the vicinity, i.e. within a spherical environment with a prescribed radius, for example, of the transmission/reception device. Similarly, communication can take place between a moving object situated on the area (e.g. a robotic vehicle) and a local transmission/reception device exclusively when the object is in the vicinity of the local transmission/reception device, i.e. when the distance between the object and the local transmission/reception device is below a prescribed value.

As a good example, communication takes place between a local transmission/reception device and a second transmission/reception element of a network element and/or between the local transmission/reception device and a moving object only when the second transmission/reception element and/or the moving object is/are within the reception range of the local transmission/reception device.

It should be noted that the at least one transmission/reception device may be produced at any location which ensures essentially undisturbed communication with a second transmission/reception element or with a plurality of the second transmission/reception elements or with all second transmission/reception elements in a sensor/actuator arrangement. In particular, when a sensor/actuator network is integrated in a surface covering, it is not necessary for the transmission/reception device likewise to be produced in the surface covering.

For the communication between the at least one transmission/reception device and a second transmission/reception element of a transmission/reception unit or of a network element, which second transmission/reception element is in the form of an RF element and is coupled to a sensor element and/or to an actuator element, the second transmission/reception element can forward sensor events to the at least one transmission/reception device (as a wireless signal at the second transmission/reception frequency) and can receive commands for activating the actuator element (actuator) from the at least one transmission/reception device as a wireless signal at the third transmission/reception frequency. The second transmission/reception element in the form of an RF element can therefore communicate wirelessly with at least one transmission/reception device arranged in the transmission range of the RF element.

Alternatively, the sensor/actuator arrangement may be configured such that a transmission/reception device communicates with a given second transmission/reception element, which in turn communicates with some or all of the other second transmission/reception elements in the sensor/actuator arrangement. In this case, the second transmission/reception element, which communicates with the transmission/reception device, can be referred to descriptively as a master element.

In line with another refinement of the invention, the sensor/actuator arrangement or the sensor/actuator network has at least one control device, which control device is configured to communicate with the at least one transmission/reception device and/or with the at least one moving object situated on the area.

The at least one control device may be in the form of a central control device, e.g. in the form of a central workstation computer, such as a PC (personal computer) or a workstation.

Alternatively, the at least one control device may also be produced in the at least one moving object, e.g. in an autonomous robotic vehicle.

The control device can communicate with the at least one transmission/reception device and/or with the at least one moving object situated on the area using a wireless communication channel, e.g. using a Bluetooth transmission standard or a WLAN (Wireless Local Area Network) transmission standard.

Alternatively, for example when the control device is in the form of a central computation device or a central workstation computer, the at least one control device and the at least one transmission/reception device can communicate by wire, for example using power line communication (PLC), using an EIB (European Installation Bus) standard or using an LAN (Local Area Network) bus standard.

Alternatively, the at least one control device and the at least one transmission/reception device can communicate using an optical data transmission path or an optical data transmission device, for example using optical fibers or fiber-optic cables.

The sensor/actuator arrangement or the sensor/actuator network may be configured such that the sensor elements and/or the transmission/reception units can be used to capture and/or provide information about the positions of moving objects and/or people situated on the area, which information is used for locating the objects and/or people; and/or that the actuator elements and/or the transmission/reception units can be used to provide the moving objects and/or people situated on the area with information, which information is used for guiding the objects and/or people on the area.

One aspect of the invention can be seen in that an arbitrary area is provided with an option for position-finding, for example in order to locate moving articles (objects), vehicles and/or people (in other words to determine the positions of the objects, vehicles and/or people on the area) and to allow navigation using a central or local control device. To this end, the area, for example the underside of a floor covering and/or a wall covering, can have a sensor/actuator network fitted, i.e. a network comprising network elements which are coupled at least in part to one another and to sensor elements and/or actuator elements. The network elements may be connected to one another and to a supply voltage by means of conductive tracks. Shorts in the network can be avoided using a power routing method, as described in [2], for example. When a supply voltage is applied to a network element or to a plurality of network elements, for example, the supply voltage connections of each network element can each be tested for shorts using an internal processor in the respective network element. The connections which do not exhibit a short can be connected at low impedance to the network element, and connections with shorts can be electronically disconnected, for example using switching elements (electronic switches or power switches). The network elements in the network can thus be successively tested for shorts, with the fault-free connections (i.e. the connections which do not exhibit a short) being able to be connected at low impedance to the network element and faulty connections (i.e. connections with shorts) being able to be disconnected (decoupled), successively for each individual network element.

In other words, when a supply voltage is applied to the surface covering structure, the power routing method described above can be used to automatically locate shorts in the network (i.e. the positions of the network elements or of the connections, which network elements or connections have shorts occurring, can be ascertained) and the shorts occurring in the network can automatically be eliminated using electronic switches (switching elements).

Another aspect of the invention can be seen in that each network element has at least one first transmission/reception element and a second transmission/reception element, one or both of which may be configured as RF elements for wirelessly sending and receiving signals (data). In other words, the first transmission/reception element and/or the second transmission/reception element can wirelessly transmit sent (transmitted) and received data, e.g. to a local transmission/reception device arranged in the transmission range of the respective transmission/reception element.

The network elements may be arranged in a regular grid and may be electrically coupled to various sensors, such as proximity sensors, temperature sensors, pressure sensors etc. and/or to actuators, such as light-emitting diodes (LEDs). Actuator elements (actuators), such as LEDs, which are arranged on the area can be activated individually or in groups from a central control device. The invention therefore allows large-area sensor systems and/or display systems to be provided, for example.

Another aspect of the invention can be seen in that the sensor/actuator arrangement or the sensor/actuator network can be used to achieve improved avoidance of obstacles in an environment which contains a plurality of moving appliances (objects) and/or people. By way of example, the combination with the active sensor system allows a person or a vehicle coming around the corner of a building to be taken into account by the system already such that approaching vehicles can be slowed down without the need for visual contact.

In other words, by way of example, a person who is moving along an area of a first corridor which is provided with a sensor/actuator arrangement, for example, can be located and the movement of the person can be tracked by virtue of the central control device evaluating the sensor events triggered by the person on individual sensor elements on the area (particularly the physical and chronological order of the sensor events), which sensor events are transmitted wirelessly, for example, to local transmission/reception devices by second transmission/reception elements coupled to the sensor elements and are forwarded from said devices to a central control device (wirelessly or by wire). At the same time, an autonomous robotic vehicle in a second corridor, crossing the first corridor, which vehicle orients itself on or in the area using wireless communication with the first transmission/reception elements of the transmission/reception units and/or with the local transmission/reception devices and/or the central control device, can have its trajectory tracked on the area of the second corridor and extrapolated using the vehicle's movement parameters (e.g. speed vector, acceleration vector). If the track calculated in advance for the robotic vehicle intersects a track calculated in advance for the person who is in the first corridor (“collision course”) then the robotic vehicle can be slowed down in good time by transmitting suitable control signals and a possible collision with the person can be avoided.

Similarly, the positions and movements of two or more moving objects (e.g. robotic vehicles) can be tracked on the area, and if necessary collisions can be avoided by transmitting suitable control signals to one or more of the objects.

By way of example, the invention can be used to advantage for locating cleaning robots or transport vehicles, in customer counting systems or customer guidance systems, e.g. in supermarkets, airports, hospitals, or generally in public or private buildings. Further exemplary embodiments are tracking of people, for example for security areas, as intruder alarm or for buildings automation, and also lighting installations in the floor for indicating emergency exits or for advertising purposes.

In other words, one aspect of the invention can be seen in that a sensor/actuator arrangement in the form of a sensor/actuator network has a plurality of transmission/reception units or network elements, which network elements can be integrated in a regular grid in a surface covering structure. The network elements may be connected to one another by means of conductor tracks or any other electrically conductive elements and may also be coupled to a supply voltage. By way of example, this has the advantage that the network elements can be operated without maintenance and sufficient power is available for a wide variety of sensors and actuators. The data communication for local transmission/reception devices or for a central control device (e.g. a central PC) or for autonomous robotic vehicles can take place wirelessly, for example using at least two different transmission/reception frequencies. This makes it possible to distinguish whether people have triggered the sensors or whether robotic vehicles are being located using integrated transmission/reception elements (RF elements). The network elements (or a respective first transmission/reception element and/or second transmission/reception element) may have a unique identification number, which identification number can be transferred once to a mapping section when the system (i.e. the sensor/actuator arrangement) is installed. In addition, the system may have a self-test implemented, which can likewise be initiated wirelessly. A first transmission/reception frequency can be used for autonomous vehicles and/or moving articles to communicate with the network elements. A second transmission/reception frequency can be used for the communication between the network elements and the local transmission/reception devices for the purpose of transmitting the sensor events (sensor signals) and the actuator control signals.

Alternatively, a third transmission/reception frequency may be used for transmitting the actuator control signals. A fourth transmission/reception frequency can be used for the communication between local transmission/reception devices and the autonomous vehicles or the central control device.

In line with another refinement of the invention, the function of the at least one first transmission/reception element of the at least one transmission/reception unit is also undertaken by the second transmission/reception element. To this end, the second transmission/reception element transmits its identification number (i.e. its explicit identification information item) wirelessly, for example at regular intervals of time. In this case, the transmission power for this regular signal (also referred to as “ping”) may have been/may be chosen such that this signal can be read by a suitable reading device only in direct proximity to the transmission/reception unit. Using what is known as a triangulation method, the precise position of the reading device can be calculated from the ping arriving on this reading device. As well as sending the identification number, the second transmission/reception element can transmit an additional identification information item or an additional identifier. The additional identifier, which is sent additionally with the pings, can be used to distinguish the pings used for locations from other messages from the second transmission/reception element (for example from sensor signals which are provided by a sensor element and which are likewise sent using the second transmission/reception element). If the reading device is fitted on a mobile article, e.g. a vehicle (for example an autonomous robotic vehicle), the precise position of the article can be calculated, In this case, triangulation can even be used to achieve a spatial resolution which is higher than the spatial resolution of the arrangement of the transmission/reception units. In line with the aforementioned refinement of the invention, it is possible to implement the navigation and/or location of a robotic vehicle using the radio modules of a sensor floor even without RFID tags, for example. In other words, the refinement of the invention which has just been described does not require the at least one first transmission/reception element in the at least one transmission/reception unit. That is to say that this refinement has only the second transmission/reception element in the transmission/reception unit. The second transmission/reception element can therefore also be referred to simply as a transmission/reception element in this case.

Exemplary embodiments of the invention are illustrated in the figures and are explained in more detail below. In the figures, elements which are the same or similar have been provided with the same or identical reference symbols, as far as this makes sense. The illustrations shown in the figures are schematic and are therefore not to scale.

In the figures:

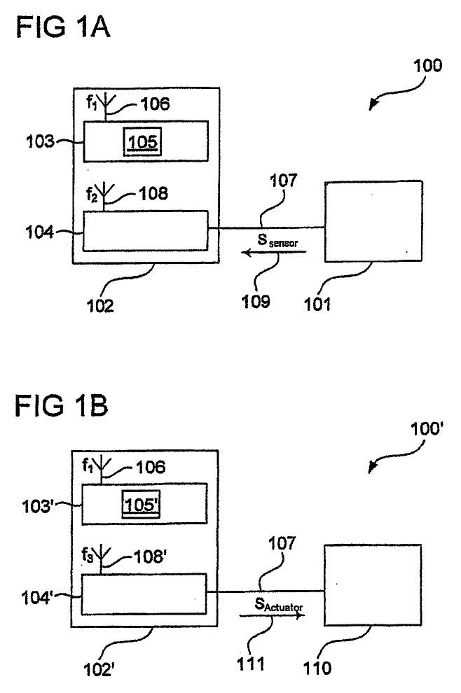

FIG. 1A shows a sensor/actuator arrangement based on a first exemplary embodiment of the invention;

FIG. 1B shows a sensor/actuator arrangement based on a second exemplary embodiment of the invention;

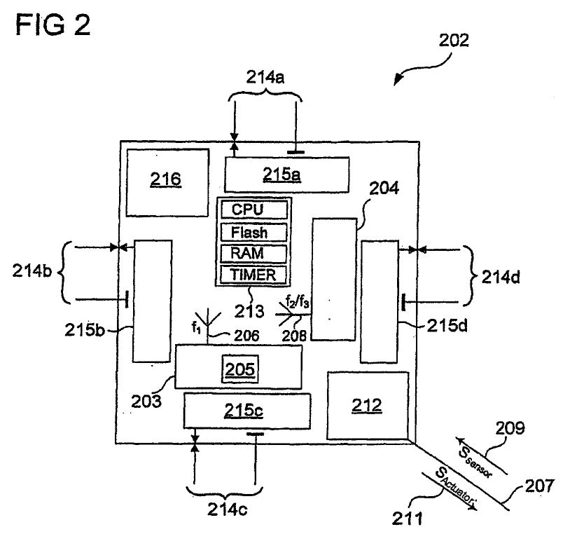

FIG. 2 shows a transmission/reception unit in a sensor/actuator arrangement based on an exemplary embodiment of the invention;

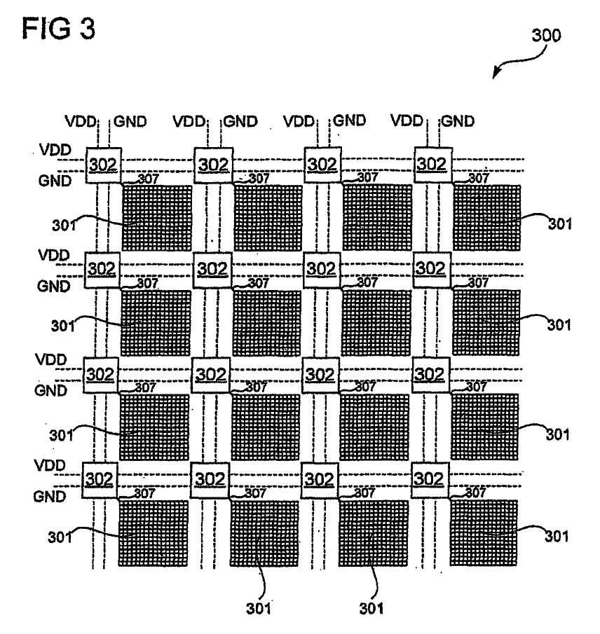

FIG. 3 shows a sensor/actuator arrangement based on a third exemplary embodiment of the invention;

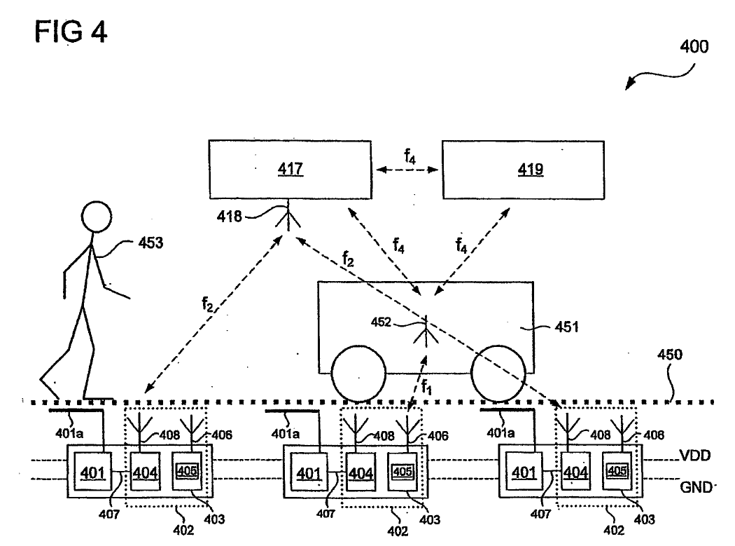

FIG. 4 shows a sensor/actuator arrangement based on a fourth exemplary embodiment of the invention;

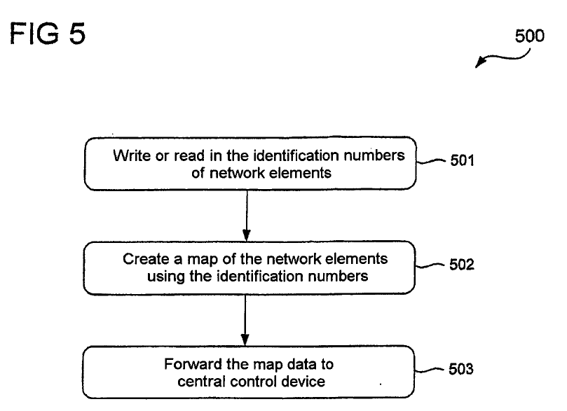

FIG. 5 shows a flowchart to illustrate individual steps in the installation of a sensor/actuator arrangement based on an exemplary embodiment of the invention; and

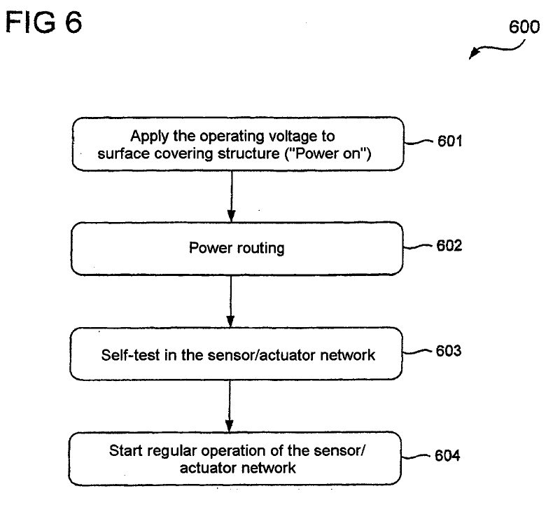

FIG. 6 shows a flowchart to illustrate individual steps in the startup of a sensor/actuator arrangement based on an exemplary embodiment of the invention.

FIG. 1A shows a sensor/actuator arrangement 100 based on a first exemplary embodiment of the invention. The sensor/actuator arrangement 100 has a sensor element 101 and a transmission/reception unit 102. The transmission/reception unit 102 has a first transmission/reception element 103 and a second transmission/reception element 104 for sending and/or receiving signals.

The first transmission/reception element 103 contains an identification information item 105 which is explicit for the transmission/reception unit 102 and which can be read (identified by the antenna symbol 106 in FIG. 1A) using a first communication channel with the aid of a wireless signal at a first transmission/reception frequency f₁, e.g. by a reading device (not shown, cf. FIG. 4) produced in a robotic vehicle.

The second transmission/reception element 104 is electrically coupled to the sensor element 101 (identified by the coupling line 107 in FIG. 1A), so that the second transmission/reception element 104 can send a sensor signal Sₛₑₙₛₒᵣ provided by the sensor element 101 using a second communication channel (identified by the arrow 109 in FIG. 1A).

In the exemplary embodiment shown in FIG. 1A, the second transmission/reception element 104 is configured such that the sensor signal Sₛₑₙₛₒᵣ can be sent as a wireless signal at a second transmission/reception frequency f₂ (illustrated by the antenna symbol 108 in FIG. 1A), e.g. to a local transmission/reception device (not shown, cf. FIG. 4), the second transmission/reception frequency f₂ being different than the first transmission/reception frequency f₁.

The first communication channel and the second communication channel are therefore each configured as a wireless communication channel in the exemplary embodiment shown in FIG. 1A.

In alternative refinements of the invention, the second transmission/reception element 104 may be configured such that the sensor signal Sₛₑₙₛₒᵣ can be sent as a wired signal.

FIG. 1B shows a sensor/actuator arrangement 100′ based on a second exemplary embodiment of the invention. The sensor/actuator arrangement 100′ has an actuator element 110 and also a transmission/reception unit 102′. The transmission/reception unit 102′ has a first transmission/reception element 103′ and a second transmission/reception element 104′ for sending and/or receiving signals.

The first transmission/reception element 103′ contains an identification information item 105′ which is explicit for the transmission/reception unit 102′ and which can be read using a first communication channel with the aid of a wireless signal at the first transmission/reception frequency f₁ (identified by the antenna symbol 106 in FIG. 1B in similar fashion to in FIG. 1A).

The second transmission/reception element 104′ is electrically coupled to the actuator element 110 (identified by the coupling line 107 in FIG. 1B in similar fashion to in FIG. 1A), so that an actuator signal S_{actuator} received using a second communication channel can be provided on the actuator element 110 (identified by the arrow 111 in FIG. 1B).

In the exemplary embodiment shown in FIG. 1B, the second transmission/reception element 104′ is configured such that the actuator control signal S_{actuator} can be received as, a wireless signal at a third transmission/reception frequency f₃ (illustrated by the antenna symbol 108′ in FIG. 1B), the third transmission/reception frequency f₃ being different than the first transmission/reception frequency f₁. The third transmission/reception frequency f₃ may be identical to the second transmission/reception frequency f₂ mentioned in connection with FIG. 1A.

By way of example, the actuator control signal S_{actuator} can be provided by a local transmission/reception device (not shown).

In alternative refinements, the second transmission/reception element 104′ may be configured such that the actuator signal S_{actuator} can be received as a wired signal.

FIG. 2 shows a transmission/reception unit 202 in a sensor/actuator arrangement based on an exemplary embodiment of the invention. The transmission/reception unit 202 has a first transmission/reception element 203, which is in the form of an RF element, and also a second transmission/reception element 204, which is likewise in the form of an RF element. The first transmission/reception element 203 is in the form of a passive RF element (e.g. in the form of a passive RFID tag) and contains an identification information item 205 (or identifier) which is explicit for the transmission/reception unit 202, e.g. in the form of an explicit identification number, which can be read wirelessly using a wireless signal at a first transmission/reception frequency f₁ (illustrated by the antenna symbol 206 in FIG. 2).

The transmission/reception unit 202 also has an electrical connection 212 which can be coupled to a sensor element or to an actuator element (identified by the coupling line 207 in FIG. 2), so that sensor signals Sₛₑₙₛₒᵣ can be received on the electrical connection 212 (illustrated by the arrow 209) or actuator control signals S_{actuator} can be provided on an actuator element coupled to the electrical connection 212 (illustrated by the arrow 211). In other words, the electrical connection 212 is used for receiving input signals from a sensor element coupled to the electrical connection 212 and for providing output signals on an actuator element coupled to the electrical connection 212.

In addition, the electrical connection 212 is coupled to the second transmission/reception element 204, so that, by way of example, a sensor signal Sₛₑₙₛₒᵣ (input signal) received on the electrical connection 212 can be forwarded to the second transmission/reception element 204, which second transmission/reception element 204 then sends the sensor signal Sₛₑₙₛₒᵣ as a wireless signal at a second transmission/reception frequency f₂, which is different than the first transmission/reception frequency f₁, e.g. to a local transmission/reception device (not shown, cf. FIG. 4) in the relatively near environment of the transmission/reception unit 202, which is identified by the antenna symbol 208 in FIG. 2.

Equally, if the electrical connection 212 is coupled to an actuator element, an actuator control signal S_{actuator} at a third transmission/reception frequency f₃ (where f₃ may be equal or not equal to f₂), which actuator control signal is received wirelessly from the second transmission/reception element 204, can be provided on the electrical connection 212 coupled to the second transmission/reception element 204, and can therefore be provided for an actuator element coupled to the electrical connection 212.

In addition to the electrical connection 212 shown in FIG. 2, further electrical connections for making electrical contact with sensor elements and/or actuator elements may be produced in the transmission/reception unit 202 (not shown), which connections may likewise be electrically coupled to the second transmission/reception element 204. In other words, the second transmission/reception element 204 can receive sensor signals Sₛₑₙₛₒᵣ from a plurality of sensor elements and/or can forward actuator control signals S_{actuator} to a plurality of actuator elements.

In addition, the transmission/reception unit 202 contains a processor core 213 with a CPU (central processing unit), a flash memory element, a RAM memory element and a timer element.

The transmission/reception unit 202 is also connected to a supply voltage source by means of a first supply voltage connection 214a, a second supply voltage connection 214b, a third supply voltage connection 214c and a fourth supply voltage connection 214d. The supply voltage provided by the supply voltage source delivers the power required for operation of the transmission/reception unit 202 and possibly of sensor elements and/or actuator elements connected to the transmission/reception unit.

The first transmission/reception element 203, which is in the form of a passive RF element, can obtain the power required for its operation from the electromagnetic field of the read signal and may therefore be operational even without coupling to the supply voltage source.

The transmission/reception unit 202 is connected to the supply voltage by means of a plurality of (i.e. the four shown in FIG. 2) supply voltage connections 214a, 214b, 214c, 214d in order to prevent failure of the transmission/reception unit 202 through redundancy.

The transmission/reception unit 202 may be produced in a network comprising a plurality of transmission/reception units which are coupled at least in part to one another and to a plurality of sensor elements and/or actuator elements (cf. FIG. 3), which transmission/reception units may be arranged in a regular grid (e.g. rectangular grid or square grid). A transmission/reception unit 202 produced in such a network comprising transmission/reception units or sensor elements/actuator elements (sensor/actuator network) is subsequently also referred to as a network element in the sensor/actuator network. In the case of a sensor/actuator network with a rectangular grid, the transmission/reception unit 202 (or the network element 202) may be coupled to at least one other network element and to up to four other network elements (transmission/reception units) which are in the closest-neighbor positions in the grid (cf. FIG. 3).

Each of the four supply voltage connections 214a, 214b, 214c, 214d of the transmission/reception unit 202 has a switching element (electronic switch or power switch) added which automatically disconnects the relevant supply path when there is a short in the network. That is to say that a first switching element 215a is electrically coupled to the first supply voltage connection 214a, a second switching element 215b is electrically coupled to the second supply voltage connection 214b, a third switching element 215c is electrically coupled to the third supply voltage connection 214c, and a fourth switching element 215d is electrically coupled to the fourth supply voltage connection 214d.

The value of the supply voltage in the network may be above the necessary supply voltage for the network element 202 in order to keep down transmission losses and to ensure sound operation. In other words, the mains voltage can be chosen to be higher than the supply voltage for the network element 202, which allows lower-loss power transmission to be achieved in the network, and which also means that voltage drops in the network can be prevented from causing the voltage on the network element 202 (and possibly other network elements) to drop below the operating voltage.

The transmission/reception unit 202 of a network element 202 shown in FIG. 2 has a voltage regulating element (switching supply) 216 or voltage regulator 216, which voltage regulating element 216 is set up such that the voltage regulating element 216 can be used to reduce the voltage to the value required for the network element 202.

FIG. 3 shows a sensor/actuator arrangement 300 based on a third exemplary embodiment of the invention. The sensor/actuator arrangement 300 has a plurality of sensor elements 301, and also a plurality of transmission/reception units 302, each transmission/reception unit 302 (to be more precise a second transmission/reception element produced in the transmission/reception unit, cf. FIG. 1A) being electrically coupled to a respective sensor element 301 (identified by the coupling lines 307 in FIG. 3). The sensor/actuator arrangement 300 is in the form of a network of transmission/reception units 302 (subsequently also referred to as network elements 302) which are arranged in a regular rectangular grid, the transmission/reception units (network elements) 302 being coupled to one another and to an electrical supply voltage source (not shown) by means of supply voltage lines VDD (high electrical potential) and GND (ground potential). Each network element 302 is coupled to its four closest neighbors in the grid, i.e. the network elements 302 in the four closest-neighbor positions. For this, a network element 302 can have four electrical supply voltage connections, and also four switching elements for preventing shorts in the network 300, a respective switching element being able to be coupled to a respective one of the four electrical supply voltage connections (cf. FIG. 2).

The sensor elements 301 and the network elements 302 in the sensor/actuator arrangement 300 in the form of a sensor/actuator network are produced in a surface covering structure for an area (e.g. a floor covering for a floor), and the network elements 302 are connected to one another via the supply voltage lines VDD and GND. In this exemplary embodiment, each network element 302 in the sensor/actuator network 300 has a respective sensor element 301 connected to it, the sensor elements 301 having sensor areas, which sensor areas are produced between the supply voltage lines VDD and GND.

Alternatively, a network element may also be coupled to a plurality of sensor elements. By way of example, a network element 302 in the sensor/actuator arrangement 300 may be coupled to two or more of the sensor elements 301 which are directly adjacent to the network element 302. In another refinement of the invention (not shown), a network element in a sensor/actuator arrangement may be coupled to eight sensor elements, which sensor elements may have a triangular shape.

Conversely, a sensor element may alternatively be coupled to a plurality of network elements. A sensor element 301 in the sensor/actuator arrangement 300 may be coupled to two or more of the directly adjacent network elements 302, for example.

The sensor elements 301 can be used to locate and/or track a person situated on the area (e.g. on the floor), for example. By way of example, a sensor area can produce a sensor signal in a pressure sensor if a person situated on the area or on the surface covering is above the sensor area. In other words, when a sensor event occurs (triggered by a person situated on the area above the sensor area coupled to the pressure sensor), the pressure sensor routes a sensor signal to the transmission/reception unit 302 (or the second transmission/reception element of the relevant transmission/reception unit 302) which is coupled to the pressure sensor, and from there said sensor signal is sent as a wireless signal (alternatively as a wired signal, e.g. using power line communication PLC) to a local transmission/reception device, for example, cf. FIG. 4. The local transmission/reception device can be used to forward the sensor signal to a central control device (e.g. a PC) which evaluates the signal and determines the position of the person therefrom. When the person moves over the area, various sensor elements (e.g. pressure sensors) successively trigger sensor events, which are accordingly forwarded as sensor signals to the coupled transmission/reception units (network elements), which transmission/reception units are able to send the sensor signals wirelessly (or alternatively by wire, e.g. using PLC) to a local transmission/reception device, from where the signals can be forwarded wirelessly (e.g. by means of Bluetooth or WLAN) or by wire (e.g. using PLC, LAN or EIB) to the central control device. The central control device can evaluate the chronological and physical sequence of the triggered sensor events and hence track the movement of the person.

FIG. 4 shows a sensor/actuator arrangement (sensor/actuator network) 400 based on a fourth exemplary embodiment of the invention. The sensor/actuator arrangement 400 has a plurality of transmission/reception units (network elements) 402 which are coupled to one another and to a supply voltage source (not shown) by means of supply voltage lines VDD (high electrical potential) and GND (electrical ground potential), which transmission/reception units 402 each have a first transmission/reception element 403, in the form of a passive RFID tag, with an identification information item 405 which is explicit for the transmission/reception unit 402 (explicit identification number of the RFID tag 403) and also a second transmission/reception element 404 in the form of an RF element, the second transmission/reception element 404 of each transmission/reception unit 402 being respectively electrically coupled to a sensor element 401 (identified by the coupling line 407 in FIG. 4). In this case, the sensor element 401 is in the form of a proximity sensor, which proximity sensor has a sensor area 401a.

The transmission/reception units 402 and the sensor elements 401 (including the sensor areas 401a) in the sensor/actuator arrangement 400 are produced or integrated in a surface covering for a floor area 450. A moving object situated on the area 450, e.g. a robotic vehicle 451, which has a reading device set up for wireless communication (illustrated by the antenna symbol 452 in FIG. 4) can identify a transmission/reception unit 402 as it drives over it and can wirelessly read the identification information item 405 which the first transmission/reception element 403 (i.e. the passive RFID tag 403) of the transmission/reception unit 402 contains using a first communication channel by means of a wireless signal at a first transmission/reception frequency f₁ (e.g. 13.56 MHz).

The identification information item 405 (i.e. the identification number of the RFID tag 403) and a map stored in a central control device 419 can be used by the robotic vehicle 452 to ascertain its current position, for example by virtue of the robotic vehicle 452 transmitting the identification information item 405 which the first transmission/reception element 403 contains (i.e. the identification number of the RFID tag 403) to the central control device 419 using a wireless communication channel (e.g. using a Bluetooth standard or a WLAN standard) and aligning it with the map stored in the control device 419. The function of the RFID tag 403 may be integrated directly in the processor nodes of a processor (cf. FIG. 2) in a network element 402.

A sensor element or proximity sensor 401 triggers a sensor signal when a person 451 situated on the area 450 is in the vicinity of the proximity sensor 401. The sensor signal is transmitted from the sensor element 401 to the second transmission/reception element 404 of the transmission/reception unit 402, said second transmission/reception element being electrically coupled to the sensor element 401. As a good example, when an event occurs, the sensor area 401a in a sensor 401 produces a sensor signal, and the sensor 401 “reports” this sensor signal to the second transmission/reception element 404.

The second transmission/reception element 404, which is in the form of an RF element, is used to send the identification number of the transmission/reception unit 402 to a local transmission/reception device 417 using a second communication channel by means of a wireless signal at a second transmission/reception frequency f₂ (e.g. 868 MHz), which local transmission/reception device 417 communicates (identified by the antenna symbol 418) wirelessly (at the frequency f₂) with the second transmission/reception elements 404 of the transmission/reception units 402 situated in the environment (i.e. in the transmission/reception range) of the local transmission/reception device 417. The location/time information for the sensor events sent using the second transmission/reception element 404 can be used in the local transmission/reception device 417 or in the central control device 419 for evaluation purposes, for example by calculating trajectories.

In an alternative refinement of the invention, the second transmission/reception element 404 of one or more of the network elements 402 produced in the surface covering for the floor area 450 may be electrically coupled to one or more actuator elements, and a second transmission/reception element 404 coupled to an actuator element can in this case receive actuator control signals as wireless signals at a third transmission/reception frequency f₃ (though it may be the case that f₃=f₂) and can provide these actuator control signals on the actuator element. By way of example, one or more of the actuator elements may be in the form of light-emitting diodes (LEDs) integrated in the floor covering, and can be used to indicate an escape route, for example.

The local transmission/reception device 417 and the central control device 419 communicate wirelessly at a fourth transmission/reception frequency f₄ (for example using a Bluetooth standard, a WLAN standard or another suitable standard for wireless communication). Alternatively, the local transmission/reception device 417 and the central control device 419 can communicate with one another by wire, for example using a home bus system (e.g. EIB bus), a power line communication device or other suitable wired communication paths. The central control device 419 can trigger various functions, such as emergency call, intruder alarm, indicator functions, inter alia, in line with the selections.

In addition, the robotic vehicle 452 shown in FIG. 4 can communicate with the local transmission/reception device 417 or directly with the central control device 419 (e.g. the central PC) wirelessly (e.g. by the fourth transmission/reception frequency f₄), as required.

The text below uses the flowcharts 500 and 600 shown in FIG. 5 and FIG. 6, respectively, to describe individual steps in the installation and in the startup of a sensor/actuator arrangement produced as a sensor/actuator network in a surface covering structure for an area.

Following installation of the surface covering structure (cf. FIG. 3), a suitable read/write device, which read/write device can communicate with the first transmission/reception element, in the form of an RF element, of the transmission/reception unit (or of the network element), is used to read the (explicit) identification numbers (step 501 in FIG. 5) which have been written into the individual network elements during production of the network elements, and the identification numbers are used to map the network elements (step 502). In addition, a coordinate system can be written into the surface covering structure during this operation. The data from the mapping are forwarded to the central control device (step 503). By way of example, the central control device may be a central PC or may also be fitted in a robotic vehicle itself. The mapping operation can take place manually or automatically using a suitable robotic vehicle. At any rate, the mapping will be a one-off or at least rarely performed operation during installation of the system.

The next phase of startup begins when the operating voltage is applied (“power on”) to the surface covering structure (step 601 in FIG. 6). When the operating voltage has been applied, a power routing method can be performed (step 602), in similar fashion to the way it is described in [2]. When a network element or a plurality of network elements has/have a supply voltage applied to it/them, an internal processor in the network element can test the other supply voltage connections of a network element for shorts. All connections which do not exhibit a short can be connected at low impedance to the network element. Connections with shorts can be disconnected electronically, for example using switching elements (“power switches”).

In other words, when applying a supply voltage to the surface covering structure it is possible to use a power routing method to automatically locate shorts in the network (i.e. it is possible to find the positions of the network elements or of the connections, which network elements or connections have shorts), and the shorts can automatically be eliminated using electronic switches.

The state of the switching elements or switches can be stored in the network element's processor and, in the next phase, the self-test on the network (step 603), can be forwarded to the local transmission/reception device (and from there to the central control device) or directly to the central control device. During the system's self-test, the local transmission/reception device can successively address each individual network element in line with the previous mapping, using the second transmission/reception frequency f₂, and can receive an acknowledgement from a respective network element, which acknowledgement can confirm that the network element is operating and also can describe the state of the switching elements (switches) and of other functional elements, such as sensor elements (sensors) and/or actuator elements (actuators). The functional state can automatically be transferred to the map. If a network element does not send an acknowledgement, an error message can be produced for this point in the surface covering structure.

In other words, a self-test on the system can involve the local transmission/reception device being used to individually address all network elements which are present on the map, to test their operation in succession and to record any error messages in the map.

If there is a relatively high density of network elements and/or a high level of redundancy for the supply voltage connections in the surface covering structure, individual instances of network parts failing will affect the operability of the overall structure only insignificantly. Following the self-test on the sensor-actuator network and the transmission of the data to the central control device, the system is operable and can start regular operation (step 604).

Autonomously driving vehicles or moving articles which are equipped with a reading device or a transmission/reception element for the frequency f₁ identify a network element when driving over it and obtain its current position from its identification number and the map which is stored in the central control device. A person walking over a sensor area in the surface covering structure triggers a signal, for example if the network element has a capacitive proximity sensor. This signal can be transmitted wirelessly using the frequency f₂ from a second transmission/reception element, in the form of an RF element, of the network element to the local transmission/reception device. The local transmission/reception element can use the location and time information in the transmission signals to calculate trajectories and define events, for example, such as burglary, a person falling or, by way of example, the last person leaving the room. This in turn allows appropriate actions to be triggered, such as an intruder alarm, an emergency call or a power-saving mode.

This document cites the following publications:

### [1] WO 2005/006015 A1

### [2] DE 103 44 285 A1

### [3] DE 101 03 302 A1

### [4] DE 197 30 794 A1

### [5] EP 1 022 923 A2

### LIST OF REFERENCE SYMBOLS

100, 100′ Sensor/actuator arrangement
101 Sensor element
102, 102′ Transmission/reception unit
103, 103′ First transmission/reception element
104, 104′ Second transmission/reception element
105, 105′ Identification information item
106 Antenna symbol
107 Electrical coupling
108, 108′ Antenna symbol
109 Arrow
110 Actuator element
111 Arrow
202 Transmission/reception unit
203 First transmission/reception element
204 Second transmission/reception element
205 Identification information item
206 Antenna symbol
207 Electrical coupling
208 Antenna symbol
209 Arrow
211 Arrow
212 Electrical connection
213 Processor core
214a, 214b,
214c, 214d Electrical connections
215a, 215b,
215c, 215d Switching elements
216 Switching supply element
300 Sensor/actuator arrangement
301 Sensor element
302 Transmission/reception unit
307 Electrical coupling
400 Sensor/actuator arrangement
401 Sensor element
401a Sensor area
402 Transmission/reception unit
403 First transmission/reception element
404 Second transmission/reception element
405 Identification information item
406 Antenna symbol
407 Electrical coupling
408 Antenna symbol
417 Transmission/reception device
418 Antenna symbol
419 Control device
450 Area
451 Robotic vehicle
452 Antenna symbol
453 Person
500 Flowchart
501, 502,
503 Flowchart steps
600 Flowchart
601, 602,
603, 604 Flowchart steps

1. A sensor/actuator arrangement, having:
at least one sensor element and/or at least one actuator element;
at least one transmission/reception unit which has at least one first transmission/reception element and a second transmission/reception element for sending and/or receiving signals;
wherein the first transmission/reception element is configured such that an identification information item contained in the first transmission/reception element can be read wirelessly using a first communication channel; and
wherein the second transmission/reception element is electrically coupled to the at least one sensor element and/or to the at least one actuator element such that the second transmission/reception element can be used to send a sensor signal provided by the at least one sensor element using a second communication channel and/or an actuator control signal received using the second communication channel can be provided on the at least one actuator element.

2. The sensor/actuator arrangement as claimed in claim 1, wherein
the first transmission/reception element is configured such that the identification information item can be read using a wireless signal at a first transmission/reception frequency.

3. The sensor/actuator arrangement as claimed in claim 2, wherein the second transmission/reception element is configured such that the sensor signal can be sent as a wireless signal at a second transmission/reception frequency.

4. The sensor/actuator arrangement as claimed in claim 3, wherein the second transmission/reception element is configured such that the actuator control signal can be received as a wireless signal at a third transmission/reception frequency.

5. The sensor/actuator arrangement as claimed in one of claims 3 and 4, wherein the first transmission/reception frequency is different than the second transmission/reception frequency and/or than the third transmission/reception frequency.

6. The sensor/actuator arrangement as claimed in one of claims 4 and 5, wherein the second transmission/reception frequency and the third transmission/reception frequency are identical.

7. The sensor/actuator arrangement as claimed in one of claims 1 to 6, wherein the identification information item contained in the first transmission/reception element is in the form of an identification information item which is explicit for the at least one transmission/reception unit.

8. The sensor/actuator arrangement as claimed in one of claims 1 to 7, wherein the first transmission/reception element and/or the second transmission/reception element is/are in the form of an RF element.

9. The sensor/actuator arrangement as claimed in claim 8, wherein the first transmission/reception element is in the form of a passive RF element.

10. The sensor/actuator arrangement as claimed in one of claims 8 and 9, wherein the first transmission/reception element is in the form of an RFID tag.

11. The sensor/actuator arrangement as claimed in claim 10, wherein the RFID tag is in the form of a writable RFID tag.

12. The sensor/actuator arrangement as claimed in one of claims 1 to 11, wherein the at least one transmission/reception unit has one or more of the following elements:
a processor element;
a memory element;
a timer.

13. The sensor/actuator arrangement as claimed in one of claims 1 to 12, wherein the at least one transmission/reception unit is coupled to an electrical supply voltage by means of at least one electrical supply voltage connection.

14. The sensor/actuator arrangement as claimed in claim 13, wherein the at least one transmission/reception unit has at least one switching element, which at least one switching element is electrically coupled to the at least one electrical supply voltage connection.

15. The sensor/actuator arrangement as claimed in one of claims 1 to 14, having at least one sensor element which is in the form of
a proximity sensor and/or
a temperature sensor and/or
a pressure sensor and/or
an optical sensor and/or
an acoustic sensor.

16. The sensor/actuator arrangement as claimed in one of claims 1 to 15, having at least one actuator element which is in the form of a light-emitting diode.

17. A sensor/actuator arrangement, having:
at least one sensor element and/or at least one actuator element;
at least one transmission/reception unit which has at least one transmission/reception element for sending and/or receiving signals;
wherein the transmission/reception element is configured such that the transmission/reception element is used for wirelessly sending an identification information item contained in the transmission/reception element using a wireless communication channel; and
wherein the transmission/reception element is electrically coupling to the at least one sensor element and/or to the at least one actuator element such that the transmission/reception element can be used to send a sensor signal provided by the at least one sensor element using the wireless communication channel, and/or an actuator control signal received using the wireless communication channel can be provided on the at least one actuator element.

18. The sensor/actuator arrangement as claimed in claim 17,
wherein the transmission/reception element is configured such that the transmission/reception element can be used, in addition to sending the identification information item, to wirelessly send an additional identification information item using the wireless communication channel, said additional identification information item being able to be used to distinguish the identification information item which is contained in the transmission/reception element and which is sent wirelessly using the wireless communication channel from other messages sent by the transmission/reception element using the wireless communication channel.

19. The sensor/actuator arrangement as claimed in one of claims 1 to 18, having
a plurality of sensor elements and/or a plurality of actuator elements;
a plurality of transmission/reception units which are electrically coupled at least in part to one another and/or to the plurality of sensor elements and/or to the plurality of actuator elements,
wherein the plurality of sensor elements and/or the plurality of actuator elements and/or the plurality of transmission/reception units are produced on or in an area.

20. The sensor/actuator arrangement as claimed in claim 19, wherein the plurality of sensor elements and/or the plurality of actuator elements and/or the plurality of transmission/reception units are produced in a surface covering for the area.

21. The sensor/actuator arrangement as claimed in one of claims 19 and 20, wherein the plurality of sensor elements and/or the plurality of actuator elements and/or the plurality of transmission/reception units are produced on the underside of a floor covering and/or on the underside of a wall covering.

22. The sensor/actuator arrangement as claimed in one of claims 19 to 21, wherein each of the transmission/reception units is coupled to an electrical supply voltage by means of at least two supply voltage connections.

23. The sensor/actuator arrangement as claimed in one of claims 19 to 22, wherein the plurality of sensor elements and/or the plurality of actuator elements and/or the plurality of transmission/reception units are arranged in a regular grid.

24. The sensor/actuator arrangement as claimed in one of claims 19 to 23, having at least one transmission/reception device for wireless communication with at least one of the transmission/reception elements or of the second transmission/reception elements in the plurality of transmission/reception elements and/or with at least one moving object situated on the area.

25. The sensor/actuator arrangement as claimed in claim 24, having at least one control device for communication with the at least one transmission/reception device and/or with the at least one moving object situated on the area.

26. The sensor/actuator arrangement as claimed in claim 25, wherein the at least one control device communicates with the at least one transmission/reception device and/or with the at least one moving object situated on the area using a wireless communication channel.

27. The sensor/actuator arrangement as claimed in claim 26, wherein the at least one control device is produced in the at least one moving object situated on the area.

28. A method for locating and/or guiding moving objects and/or people on an area using a sensor/actuator arrangement as claimed in one of claims 19 to 27,
wherein the sensor elements and/or the transmission/reception units are used to capture information about the positions of moving objects and/or people situated on the area, which information is used for locating the objects and/or people; and
wherein the actuator elements and/or the transmission/reception units are used to provide the moving objects and/or people situated on the area with information, which information is used for guiding the objects and/or people on the area.
